(19) United States
(12) Patent Application Publication
(10) Pub. No.: US 2008/0275690 A1
(43) Pub. Date: Nov. 6, 2008

(54) Automated visualization of a selection of simulation data

(75) Inventors: Martin Brull, Barbing (DE); Thomas Burger, Regensburg (DE); Ralf Muller, Bad Abbach (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AKTIENGESELLSCHAFT

(21) Appl. No.: 12/148,116

(22) Filed: Apr. 16, 2008

(30) Foreign Application Priority Data
Apr. 17, 2007 (EP) 07007829.0

(51) Int. Cl. G06F 9/45

(52) U.S. Cl. 703/22

(57) ABSTRACT

The visualization of a selection of data can be simplified. The data occurs during the execution or simulation of a function model on a computer system. It is possible in particular to configure the process of designing or developing functionalities of a control device (e.g. a motor control device) more efficiently. Software operating on the computer system is configured to use a set of rules to select some of all the data items occurring in the function model automatically as the data items to be visualized. A continuous and automated solution for the definition, selection and visual display of the data items required in individual instances is allowed.

### CROSS REFERENCE TO RELATED APPLICATIONS

This application claims priority of European Patent Office application No. 07007829.0 EP filed Apr. 17, 2007, which is incorporated by reference herein in its entirety.

### FIELD OF INVENTION

The present invention relates to the execution or simulation of a function algorithm on a computer system. The term “function algorithm” here is used in contrast to the purely mathematical term “algorithm” to express that it can be used to handle functions in the real world, for example control or regulation tasks. In particular when designing or developing software, which provides such a function algorithm, it is desirable, when executing or simulating the function algorithm on a computer system, for the data resulting in the process to be visualized (e.g. screen display).

### BACKGROUND OF INVENTION

When designing and/or developing or modifying relatively complex software-implemented function algorithms, the problem arises for the designer charged with the task that during execution or simulation a plurality of data occurs that is no longer clear to a person. To resolve this problem, a method is desirable for visualizing only a selection of the occurring data.

The present invention relates in particular to the field of function design for control devices, for example for motor control devices for operating internal combustion engines. During the execution or simulation of function algorithms relating to these, a plurality of data occurs, which is too much for an individual designer to take in and anyway is not necessary for the respective design task from a practical point of view.

Motor control devices, as used in modem motor vehicles to control an internal combustion engine and typically also used to control and/or regulate further electrical or electronic vehicle components, have become increasingly complex in recent years. Incorporation in functions provided therewith and analysis of problems during the design and development of motor control devices are correspondingly complex.

The so-called rapid prototyping method is often used in the context of function design for microprocessor-controlled control devices. With this a model that is capable of simulating one or more functionalities, referred to below as a function model, is established on a computer system (e.g. PC), which can ultimately be linked using corresponding tools (generally hardware and software components) to an existing control device, so that it operates as part of the control device functionality. It then represents a so-called bypass.

The functionality under consideration therefore represents part of the overall control device functionality and runs either on a separate device connected to the control device (microcontroller or rapid prototyping unit) or within the control device itself. In the first instance we refer to external rapid prototyping, while the second instance is generally referred to as internal rapid prototyping.

With less complex control device functionalities it is also possible to operate all the functionalities using rapid prototyping tools (so-called fullpass).

A “function model” within the meaning of the invention is the basis for or a specific embodiment of a function algorithm. A function model is made up of individual model parts or elements.

The different terms “execution” and “simulation” are intended to express that the visualization of a selection of data can on the one hand serve to ensure that for example the designer of a control device functionality understands or observes the mode of operation and usability of the function algorithm or function model better and on the other hand serves to ensure that the function designer uses the visualization of the relevant data to make immediate modifications to the function algorithm and to investigate or check the impact of these (again using the visualization). During the simulation of a function model the function designer can for example remove individual model parts from the model, insert them into the model or modify links (data path elements).

For the isolated creation and simulation (test) of a function model on a computer system the function designer can use commercially available software packages (e.g. Matlab/Simulink/Stateflow, Solutions for Control, Ascet/Intecrio). Such simulation tools can have a graphic user interface for example, which can be used to create the function model from individual model parts. Model parts here include for example function units (e.g. adding units, subtracting units, etc.) as well as data path elements to connect the function units.

In the context of the simulation of the function model the software also allows the interfacing of data generators to provide input data of the function model or individual function units as well as the interfacing of data visualization units at data outputs of function units or at a data path element, to visualize the relevant data. The term “visualization” here is intended to signify that a representation of the relevant data is output using an output facility of the human-machine interface of the computer system, in other words for example on a screen.

A plurality of data occurs, in which it is possible to distinguish roughly between for example “variables” and “parameters”, in particular for relatively complex control device functionalities, as are present for example in the case of a motor control device for an internal combustion engine.

Variables of the function model can be for example input data and/or output data of the model or individual model parts. Also data in the form of intermediate results of calculations (implemented using the function units) generally occurs in the model. The input and output data can for example be measurement signals (sensor data) or control signals (e.g. to activate actuators).

Parameters of the function model are preset and modifiable quantities and generally serve as “calibration data” for tailoring the quantities of functionalities.

With the prior art the function designer is able, with specific operating software, to access corresponding data, display it and reset parameters during simulation of the function model (for example to carry out measurements and/or calibration tasks). For this the designer must use the model to analyze which data is needed, use this operating software in a manual and therefore very complex manner to define which data is to be displayed in one or more windows of a screen output and how the data selected in this manner is to be arranged within the data output.

Complex function models generally contain a very large number of variables and parameters. With the known software tools for creating and simulating function models not all the data required in practice by the function designer is usually also generated as measurable data, in other words data that can be selected manually for visualization. On the other hand such standard software provides visualization possibilities for much data (i.e. storage locations provided specifically for it), which may be of no value to the function designer in the specific application.

For function design the manual definition or selection of the data required for a visualization in the operating software represents a time-consuming activity. Also data changes can occur for every function change undertaken, requiring redefinition or verification of the previous definition in respect of the visualization, representing a further time outlay and being susceptible to error. There is generally a significant loss of efficiency during the function design process with known methods for visualizing a selection of data from all the data occurring.

### SUMMARY OF INVENTION

An object of the present invention is to simplify the visualization of a selection of data occurring during an execution or simulation of a function algorithm, in order to be able in particular to configure the process of designing or developing functionalities of a control device for example more efficiently.

The idea underlying the invention is to specify an automated solution for the definition and/or selection of the data to be visualized.

According to the invention a method is provided for visualizing a selection of data, which occurs during the execution or simulation of a function algorithm on a computer system by means of software operating thereon, with the software being configured to use a set of rules to select some of all the data occurring in the function algorithm automatically as the data to be visualized.

The “set of rules” is to an extent another algorithm, which automatically selects the data to be visualized. However this algorithm should not be confused with the function algorithm, in which this data occurs.

The invention provides a continuous and automated solution for the definition, selection and visual display of the data required in individual cases (model quantities).

The core of the invention consists in that the data required by the function designer (e.g. representing physical quantities) is defined in a simple manner in the function model and ultimately is also automated in a simple manner, more specifically can be displayed using a software-implemented set of rules (algorithm). A function model itself can represent the central source for selection of the data to be visualized. Alternatively a different source, in particular a central source (for all occurring data) can be provided for the information used by the set of rules to select the data.

Manual and therefore very complex definition or selection of data to be visualized, as provided in the prior art, can be dispensed with according to the invention.

In one development of the invention provision is made for the set of rules also to define the positioning of the individual data items to be visualized. For example display elements for displaying the selected data can be set up automatically by the software. In this process stored layouts can also be used, which are preferably searched for and configured as a function of the required data. Alternatively or additionally layouts can also be established as a function of the required data according to the set of rules.

Information about the required data can hereby be transmitted for example actively from the function model to the software (e.g. operating software) or can be called up by the software. (For example from the model itself or from another information source)

The positioning of the individual data items to be visualized can comprise for example both positioning within a data output window of a graphic output surface of the computer system used as well as the arrangement of a number of such windows.

In one preferred embodiment provision is made for the software to be configured to that an operator of the computer system can modify the set of rules. If the set of rules also defines the positioning of the individual data items to be visualized, the possibility of modifying the set of rules can also relate to the corresponding positioning rules. The possibility of modifying the set of rules has the particular advantage for example that different operators entrusted with different tasks in the context of function design can each effect the visualization of an individual selection of data using the same function algorithm or function model. The function algorithm per se does not have to be modified by the operator in question in this process.

The data that can be selected in any case by the set of rules as data to be visualized is preferably defined in the function model itself. In this instance a user can advantageously make a further restricting selection individually based on the possibility of modifying the set of rules.

In one development provision is made for inputs to be required from the operator during the establishment of display elements at the relevant output facility, said inputs restricting the scope of the data to be visualized and/or influencing the arrangement of the display elements (e.g. screen windows). Alternatively or additionally configuration files present in the computer system can also be read out to establish the display elements.

In one development of the invention provision is made for the set of rules also to take into account current data values during the selection and/or positioning of the data items to be visualized. Provision can hereby be made for example for individual data items only to be visualized, if their current value satisfies certain criteria predetermined by the operator. Such a criterion can for example be that the relevant data value is above or below a predetermined threshold. An operator is able to input one or more such thresholds, for example when modifying the set of rules.

In one embodiment provision is made for the function algorithm to be based on a function model and for this function model to contain respective data identifiers for all the data items occurring in the function model and for the set of rules to take into account these identifiers when selecting and/or positioning the data to be visualized.

In a simple instance the data identifier determines whether or not the relevant data item is to be visualized. However in practice this embodiment is generally disadvantageous, because, when a different selection of data items to be visualized is required, it is necessary to modify the corresponding data identifiers, in other words the function algorithm or the associated function model itself.

To eliminate this disadvantage one embodiment is of interest, in which the data identifiers of the individual data items occurring in the function model do not directly specify whether or not the data items are to be visualized but only specify a “data type” for the relevant data item, which the software-implemented set of rules then uses to decide on the question of visualizing said data. This advantageously results in a greater flexibility of the inventive visualization method, particularly if the set of rules can be modified by the operator of the computer system, so that each operator can employ their individual visualization criteria, without modifying the function model as such.

For example a first operator, who is interested in the physical/technical usability of the function model, could effect the visualization of the relevant input data and output data for example by appropriately tailoring the set of rules, while a second operator, wishing to locate an error in the function model, can also effect the visualization of intermediate results of calculations within the function model for this purpose. As an alternative or in addition to the visualization of specific variables, a visualization of parameters of the function model may also be of interest to an operator wishing to carry out a calibration of function units and/or the functionalities realized therewith in the context of function design.

Account can be taken particularly advantageously of all these very varied requirements of the individual operators in that the data identifiers only contain information about the type of data, with the selection for the purposes of visualizing the data (and in some instances positioning the data) being carried out exclusively by the set of rules, which can however preferably be modified.

In one embodiment provision is made for the data identifier to be an evaluation of the circumstance whether the data in question is input data or output data of a function used in the function algorithm or in an underlying function model, said function being associated with a specific function class.

There are a wide range of options in practice for the definition of “function classes”.

For example function units of the function model, to which input data of the model is not supplied directly and which do not supply output data of the model directly, could form a specific “intermediate calculations” function class.

In contrast function units, which are supplied with input data of the model or supply output data of the model, could be assigned to specific “input functions” and/or “output functions” function classes.

Function units could also be assigned respectively to one or more function classes, which specify a physical/technical relevance of the incoming or outgoing data (e.g. “relevant for calibration”, “relevant for ignition point calculation”, “relevant for brake anti-lock function”, etc.). Such broad criteria or attributes can be very helpful as data identifiers, to allow the operators of the computer system to tailor the set of rules in a corresponding individual manner based on these data identifiers. Thus for example an operator can modify the set of rules correspondingly to effect the visualization of generally only calibration data or for example only data belonging to a specific sub-functionality (e.g. injection control, brake control, transmission control, etc.) during simulation of the function model.

In one embodiment provision is made for data identifiers to be obtained by parsing function names or data names used in the function model, which were assigned by an operator when the function model was created. This measure allows a particularly high degree of flexibility to be achieved for the method. A function designer can advantageously assign the function names and/or data names (of the data path elements) used in the model on the computer system according to a predetermined convention (e.g. capitalization, non-capitalization, specific prefix and/or suffix, specific name component, etc.), in order thereby to establish the foundation for a simple automated selection of the data to be visualized to a certain extent.

According to one embodiment provision is made for data identifiers to be formed by a data type. As mentioned above, data can be classified for example as “variables” and “parameters”, already representing one aspect of the relevant data type. The data type can alternatively or additionally also contain further aspects. For variables the data type can for example specify whether it is an input signal of the function model, an output signal of the function model or intermediate results within the model. The data type and/or a data identifier based on the data type could also relate to physical/technical significance content (e.g. “sensor signal”, “measurement signal”, “control signal”, “analog signal”, “digital signal”, “intermediate calculation result signal”, etc.). Alternatively or additionally the data type can also relate to the association with a specific function class (input and/or output data of a function unit associated with the function class). A function class here can be defined for example by mathematical characteristics of the associated functions, as mentioned above by the arrangement of the function unit within the function model (e.g. “input function”) or even be defined by predetermined characteristics of the function name assigned by the creator of the function model.

In one embodiment provision is made for the function model to contain a data identifier block provided specifically to provide the data identifier. According to this embodiment data provided for visualization is identified by way of specific additional elements or blocks (selection blocks). In particular an additional data identifier block for example can be inserted into the function model, for example when the model is created, having specific setting options (defined by the software). In particular a setting could be provided to determine whether or not the data in question should be visualized. Alternatively or additionally a data identifier block could serve to indicate or specify a data type for all the data occurring in a model. Such a data identifier block can also be provided outside the function algorithm or function model, in particular for example as a “central information source”, which is used by the set of rules when selecting the data to be visualized. In this instance the individual data items or data path elements of a function model could be provided with directly “adhering” data identifiers, which only represent a software-based reference to a specific location within the central information source, in which the information can ultimately be found, which is required by the set of rules for data selection. In one purely exemplary embodiment the setting options can be realized at the data identifier block of the model by means of a graphic user interface, for example by way of selectable markings in a list of the data items contained in the model.

### BRIEF DESCRIPTION OF THE DRAWINGS

The invention is described in more detail below based on exemplary embodiments with reference to the accompanying drawings, in which:

FIG. 1 shows a function model with interfaced data generators and data visualization unit,

FIG. 2 shows a graphic representation of a function contained in the function model,

FIG. 3 shows a graphic representation of a further function contained in the function model, and

FIG. 4 shows a screen display with data visualization windows.

### DETAILED DESCRIPTION OF INVENTION

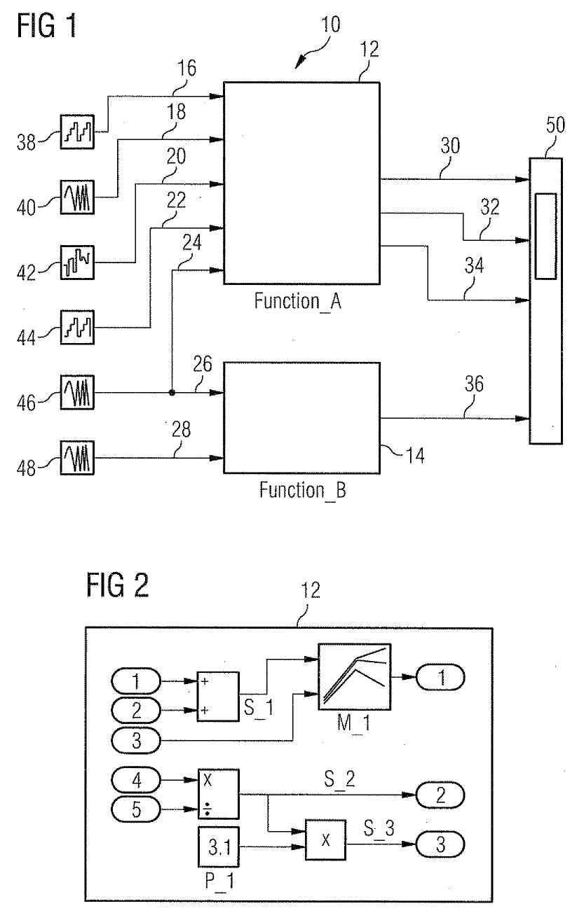

FIG. 1 shows an example of a function model 10, having two functions or function units 12 and 14.

The function model 10 also has data path elements 16 to 36, which lead to data inputs of the functions 12 and 14 or from data outputs of said functions in the manner shown.

In the exemplary embodiment shown the function 12 has five data inputs and three data outputs, while the function 12 has two data inputs and one data output.

A simulation capability of the model 10 results from the illustrated interfacing on the one hand of data generators 38 to 48 to provide input data of the model 10 by way of data path elements 16 to 24 and 28 and on the other hand of a data visualization unit 50, at which the output-side data path elements 30 to 36 end.

The data path element 26 is a data path branching from the data path element 24, as shown. This means, as shown, that a function input data item generated by the data generator 46 is routed both (by way of the path 24) to a data input of the function 12 and (by way of the path 26) to a data input of the function 14.

Function models like the function model 10 illustrated can be established in the prior art using commercially available modeling and simulation software and can be graphically represented as shown by way of example in FIG. 1 It should be noted here that the exemplary function model 10 is set up in a relatively simple manner. In practice, for example when creating and simulating function models for individual or all functionalities of a microprocessor-controlled control device for an internal combustion engine, there are generally very many more functions and data paths present than are shown in Fig.

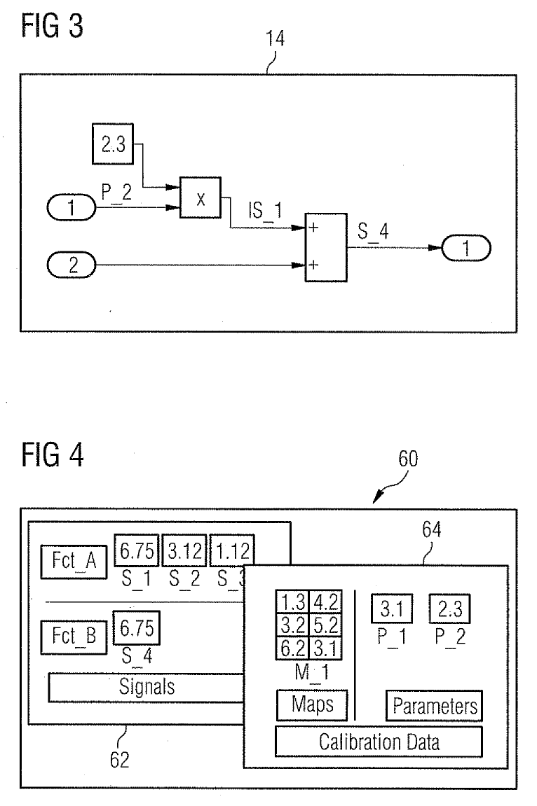

FIGS. 2 and 3 show the internal structure of the function units 12 (FIG. 2) and 14 (FIG. 3).

It can be seen from these diagrams that each of the functions 12 and 14 in turn, like the overall model 10, is formed from a number of function units, which are linked by function-internal data path elements. The function model 10 is therefore advantageously made up of modules (in this instance: function units 12 and 14), which can advantageously be drawn from a range of such modules when creating the function model. This has the advantage for example that frequently required functions can be stored within the modeling and simulation software in a module library, which the user can easily access to create a specific function model therefrom. The user can also define new function units by way of a graphic user interface and integrate them in the library.

Although it is clear to those skilled in the art from the self-explanatory diagrams in FIGS. 1 to 3 how the model output signals at paths 30 to 36 are calculated from the model input signals at paths 16 to 24 and 28 (generated by the data generators 38 to 48), only the calculation of the data output by way of the data path 30 is described in detail below by way of example:

The data output at the path 30 is the output data of a parameter map M_1. This parameter map M_1 is supplied on the input side with two variables. A first variable is shown in FIG. 2 as S_1 and is obtained by adding the data items supplied by the data generators 38 and 40 by way of the data paths 16 and 18 to the model 10 (see FIG. 1). The second input variable for the parameter map M_1 is formed by the data item generated by the data generator 42 and supplied by way of the data path 20.

FIGS. 2 and 3 show the contents of the two function model parts 12 and 14 of the function model 10.

A particular feature of the function model 10 or the model parts 12 and 14, from which the function model 10 is formed, is the assignability of arbitrarily allocated names to all elements of the model 10 and all elements of the function units 12 and 14.

Thus in the example shown the function units 12 and 14 have the function names “Function_A” and “Function_B”. Although this is not shown explicitly in FIG. 1, the modeling and simulation software used here thus also allows the allocation of names for the data routed by way of the data path elements 16 to 36. As shown in FIGS. 2 and 3 the software also allows the allocation of names for all elements of the functions (in this instance functions 12 and 14). Thus for example “M_1” is the name of the parameter map mentioned above, which forms an element of the function 12. The data item supplied at a first data input of this map is, as shown in FIG. 2, given a data name “S_1”. The second input-side data item for the map has no data name in the example shown.

The names allocated by the creator to function units and data have the advantage that the creator can retain a better overview of the significance of the individual functions and/or data. In the example shown for example names starting with the prefix “S” or “IS” were used for signals (S) and intermediate signals (IS; obtained by calculation on one or more signals or intermediate signals). In contrast data names starting with the prefix “P” were used to designate parameters. Parameter maps start with the prefix “M”. Such a convention for allocating names makes it possible to express a data type of the data in question or a function type of the function units in question clearly in an intuitive manner.

In the context of the present invention however the allocated names of the model parts do not simply serve the better understanding of the creator or a processor of the function model 10, but are used in an automated visualization method by the modeling and simulation software.

When simulating the function model 10 this software generates a visual representation of a selection of data occurring in the function model.

FIG. 4 shows an example of a visualization generated by the software used in the form of a screen output 60 of the computer system used.

In the example shown the screen output comprises two output windows 62 and 64, with the signals occurring in the function model 10 being visualized in the window 62 while the window 64 serves to visualize calibration data.

In the present example the names given to the elements of the function model 10 help to determine which quantities are visualized at all and optionally in which of the output windows 62 and 64. A set of rules is stored in the software, which uses predetermined criteria to determine whether and in what form or arrangement a respective data item is displayed.

In the present example the software-implemented set of rules determines for example that all the data items occurring in the function model 10, whose data names start with the prefix “S” are visualized in the output window 62, while model parts or data items, whose names start with the prefix “M” or “P” are visualized in the output window 64.

The set of rules also allows positioning of the data to be visualized to be realized in a simple manner as a function of the names allocated, resulting in a transparent, clearly defined layout of the visualization output 60.

In the example shown the set of rules defines both the separate representation of signals and calibration data (parameters, maps) and a corresponding grouping within the respective output windows 62 and 64. Information is also taken into account relating to the function (in this instance Function_A or Function_B) of the function model 10 in which a data item was defined (as input data or output data). It has also been stored as a rule that intermediate values like the data item “IS_1” are not displayed.

The operating software is therefore advantageously able automatically to visualize the data items required individually by a user of the computer system and arrange it in predetermined display areas based on the information present in the function model (in particular for example the allocated names) and the stored set of rules. Alternatively the visualization layout could also be established by a separate tooling, which then supplies already established visualization layouts to the actual operating software.

An advantageous further characteristic of the software running on the computer system is that it is designed for the possibility of modifying the set of rules on which the visualization method is based. Thus an operator of the computer system can for example tailor the set of rules to their individual needs, without having to modify the function model 10 to do so. For example an operator can specify, by simply tailoring the set of rules, that only calibration data or only data relating to a specific physical/technical functionality (e.g. fuel injection calculation data) is visualized.

With the described exemplary embodiment the set of rules for selecting and/or positioning the data to be displayed takes into account respective data identifiers obtained by parsing the function names and file names used.

Although this was not described explicitly for the simple exemplary embodiment, such data identifiers can alternatively or preferably also be defined or jointly defined in a different manner. In this instance too all the data identifiers are preferably already contained in the function model, so that different users of the same function model can advantageously ultimately define the data to be visualized and its positioning in a graphic output by simple tailoring of the set of rules. Data identifiers can also be determined and taken into account by the software independently of the names allocated to individual data items or individual function units. Finally it is alternatively or additionally possible for a function model, like the function model 10 shown in FIG. 1, to have a data identifier block provided specifically to supply data identifiers.

In summary the invention provides an advantageous and universally employable method for visualizing a selection of data, which occurs when executing or simulating a function algorithm, in particular a function model on a computer system. The selection of the data items to be visualized from all the occurring data items is made in an automated manner based on a set of rules. This allows a continuous and efficient solution to be created in particular for the design or development of control devices, wherein the desired selection of data ultimately depends on information, which may be contained in full in the function model itself or may be associated with the function model. This can also include files and/or information derived from the relevant function model or referenced by specific data identifiers.

Data identifiers, which can be evaluated in a software-controlled manner for the question of visualization, can result from the use of specific function units or data path elements, in particular their mathematical characteristics or their association with a specific physical/technical functionality or their names. If for example, when integrating function units and data path elements associated therewith, which relate to calibration functionalities, specific “calibration blocks” are used (e.g. defined by their names or other specific characteristics), a user can specify in a simple manner that all the data relating to calibration tasks is visualized, by corresponding tailoring of the set of rules or by selecting a predefined setting of the set of rules. Alternatively it is possible to identify uniquely, for example by means of specific settings that can be made at each individual function unit or each individual data path element, whether the data item represented with the model part should be available for visualization.

The invention can also be employed for general calibration applications independently of the specific application of rapid prototyping. Thus a function designer can for example already make significant efficiency-enhancing preparations for the subsequent calibration phase of control device design or development. The invention can also be used when producing model documentation. In this instance the selection of data to be visualized and its positioning can be used directly as part of the technical documentation to be created for the function model in question.

In one advantageous embodiment data of relevance to the visualization can be identified by specific data parameters or data names, which are allocated according to a convention taken into account by the software. Name allocation alone or in combination with a check for specific name components or compositions can, like the setting of specific data parameters, be considered as a unique identifier of data which is of relevance for visualization and/or is actually to be displayed according to the current setting of the set of rules.

Use of the invention in practice in particular has the following advantages for example:

A very high level of efficiency for the function designer when carrying out rapid prototyping. There is no need for the time-consuming manual establishment of layouts for the visualization of specific data. When a function model has been newly set up or modifications have been made to the function model, an operator can calibrate the functionality immediately and carry out measurements without wasting time.

Method continuity. The function model can be the single central source for data definitions and the automated establishment of layouts for visualization can be structured and standardized by defined sets of rules.

Avoids error: errors such as the displaying of incorrect data (due to name confusion) or forgetting to visualize important data can be avoided by the continuity and maximum degree of automation offered by the method.

1-11. (canceled)

12. A method for visualizing a selection of data occurring during execution or simulation of a function algorithm, comprising:
providing a computer system;
executing or simulating a function algorithm on the computer system;
providing a set of rules to select automatically a plurality of data from data items occurring in the function algorithm;
selecting automatically the plurality of data from all data items occurring in the function algorithm base upon the set of rules; and
visualizing the selected plurality of data.

13. The method as claimed in claim 12, wherein the selection of the plurality of data is performed from all data items occurring in the function algorithm.

14. The method as claimed in claim 13, wherein the set of rules defines a position of the individual data items visualized on a display.

15. The method as claimed in claim 12, wherein the set of rules is modified by an operator of the computer system.

16. The method as claimed in claim 14, wherein the set of rules is modified by an operator of the computer system.

17. The method as claimed in claim 12, wherein the selection or the positioning of the data items to be visualized is based upon current data values.

18. The method as claimed in claim 12, wherein the function algorithm is based upon a function model, wherein the function model contains respective data identifiers for all the data items occurring in the function model, wherein the selection or positioning of the data items to be visualized based upon the set of rules depends on the data identifiers.

19. The method as claimed in claim 16, wherein the function algorithm is based upon a function model, wherein the function model contains respective data identifiers for all the data items occurring in the function model, wherein the selection or positioning of the data items to be visualized based upon the set of rules depends on the data identifiers.

20. The method as claimed in claim 18, wherein the data identifier is identifies input data and output data of a function in the function algorithm, wherein the function is associated with a function class.

21. The method as claimed in claim 19, wherein the data identifier identifies input data and output data of a function in the function algorithm, wherein the function is associated with a function class.

22. The method as claimed in claim 18, wherein the data identifiers used by the set of rules are obtained by parsing function names or data names used in the function algorithm, which were allocated by an operator when creating the function algorithm.

23. The method as claimed in claim 19, wherein the data identifiers used by the set of rules are obtained by parsing function names or data names used in the function algorithm, which were allocated by an operator when creating the function algorithm.

24. The method as claimed in claim 12, wherein the data identifiers is a data type.

25. The method as claimed in claim 12, wherein the function algorithm has a data identifier block to supply data identifiers.

26. The method as claimed in claim 23, wherein the function algorithm has a data identifier block to supply the data identifiers.

27. The method as claimed in claim 18, wherein the data identifiers used by the set of rules are formed by references, which refer to locations in a central information source.

28. The method as claimed in claim 26, wherein the data identifiers used by the set of rules are formed by references, which refer to locations in a central information source.
